(19) United States
(12) Patent Application Publication
(10) Pub. No.: US 2005/0209397 A1
(43) Pub. Date: Sep. 22, 2005

(54) Ink formulations containing rubber additives

(76) Inventors: Sel Avci, Kendall Park, NJ (US); Mahalingam Santhanam, Plainsboro, NJ (US); Dan Merchant, East Brunswick, NJ (US); James Gambino, Yardley, PA (US); Wilbur Mardis, Holland, PA (US)

Correspondence Address: RHEOX, INC.;WYCKOFFS MILL ROAD, P O BOX 700, HIGHTSTOWN, NJ, 08520, US

(21) Appl. No.: 10/801,284

(22) Filed: Mar. 16, 2004

(51) Int. Cl. C08K 3/00

(52) U.S. Cl. 524/571

(57) ABSTRACT

Printing inks have their performance improved by use of additives derived from rubber polyisoprenes “built-up” from rubber precursors or degraded using known techniques. A weight average molecular weight for the additives between 10,000-40,000 daltons has been found particularly effective and a loading between 1 and 10% optimum.

### FIELD OF THE INVENTION

This invention relates to non-aqueous ink systems containing additives based on rubber. The additives used in the present invention provide novel ink formulations with improved physical properties such as rheology with no diminution in anti-misting. This invention relates particularly to heatset printing inks but is useful for other ink formulations.

### BACKGROUND OF THE INVENTION

1. BRIEF DESCRIPTION OF THE INVENTION

This invention is of improved printing ink formulations containing defined rubber additives. The rubber additives involved are mixed or dispersed into such printing ink formulations and impart to the ink formulations improved rheology with no misting impact during printing. These rubber additives can in this use be referred to as rheological ink additives.

The invention hereof is particularly directed to heatset, sheet-fed and UV curable printing inks.

2. Description of the Prior Art

Ink Systems and Additives

It is known that additives to ink formulations in addition to pigments can provide such formulations with improved rheological properties. Additives are often added into printing ink formulations during manufacture by being mixed, or ground, into the ink formulation along with the pigments used to make ink, or added as a part of the final ink blend, or introduced at other times. Such additives, for example, have also been dispersed into precursor ink solvents or resins.

This invention has particular value in specific classes of inks. Offset inks such as heatset, sheetfed and UV curable inks generally include one or more vehicles, one or more colorants and one or more solvents as principal components. Heatset web offset inks dry under the action of heat by the evaporation of the high boiling solvents. Heatset offset inks may include resins such as hydrocarbon or phenoxy modified rosin esters, colorants such as one or more pigments, and solvents such as petroleum derivative high boiling point solvents, and additives such as waxes and rheology control agents. Sheetfed offset inks are also in paste form that dry through oxidation process. Sheetfed offset inks may include resins such as alkyd resins, hydrocarbon or phenoxy modified rosin esters, colorants such as one or more pigments, drying oils such as linseed or vegetable oils, dryers such as cobalt or manganese, and additives such as waxes and rheology control agents. Ultra Violet or UV curable offset inks are paste inks that dry through polymerization of the UV curable polymers utilized in the ink formulation. UV curable offset inks may include polymers such as acrylated-oligomers, diluents such as monomers, colorants such as one or more pigments, photoinitiators, and additives such as inhibitors, waxes and rheology modifiers.

Ink rheological additives in commercial use today are often in either a wax-like, solid or powder form and not in liquid form. Organoclays, for instance, have been widely used as ink additives and are incorporated both as rheology control agents and as anti-misting agents. The assignee hereof, Elementis Specialties, Inc. has long offered a line of rheological products sold under the trademark BENTONE™ to ink manufacturers who incorporate such organoclays in much of their ink formulation product lines.

The incorporation of organoclays and many other commercial ink additives present similar conventional handling problems as are encountered with the dispersion of other types of solid or nearly-solid materials. When added to ink systems, such types of prior art products can agglomerate into clumps. When dispersed directly, “uneven wetting out” of the product sometimes results in the formation of lumps or globules whose core is still dry. Such agglomeration can be reduced in many cases by adding the prior art additives to the system slowly, with agitation. Such slow addition however often reduces the efficiency of specific ink manufacturing operations.

Many additives have proved difficult to incorporate in industrial ink-making processes because they often require long periods of time to incorporate. Both in simple ink resin solutions and, more particularly, in ink formulations comprising other chemicals and ingredients, extended agitation and aging periods are necessary before correct viscosity and dispersion can be attained.

Ink manufacturers have continually searched for simple, fast and effective ways of mixing additives into ink systems. Because of this continuing desire and investigation, some commercial products are used by ink manufacturers as pourable liquid “concentrates.” These additives, in liquid form for inks and other compositions, usually involve taking the solid powder additive sold by a manufacturing company and preparing, by the ink manufacturer, at his ink manufacturing operation a pre-mix liquid mixture or blend of the additive and the ink vehicle being used to incorporate into the ink formulation or a liquid component of such formulation.

A number of representative prior art patents describe the use of ink additives useful in ink formulations. For example, U.S. Pat. No. 5,024,700 describes the use of triethanolamine as an ink additive, which among other properties, is described as providing improved rub resistance to oil and resin-based ink compositions. The product is claimed to be particularly useful for newspaper printing applications in this regard. U.S. Pat. No. 5,035,836 shows an ink using a polymer-based binder and an electrically conductive solid lubricant.

Some patents describe the use of polytetrafluoroethylene in non-ink applications, see for example U.S. Pat. No. 5,159,019 which teaches the use of polytetrafluoroethylene in a resin mixture to provide abrasion resistance to injection molded plastic materials.

Recent U.S. Pat. Nos. 6,489,375 and 6,451,873 granted to Sun Chemical Corporation describe the use of resin-based rheological additives for web offset heatset inks. Flint Ink Corporation has also recently been awarded patents in lithographic inks which describe the high degree of scientific effort devoted to printing ink because of the number of performance requirements for such inks and the balancing of these requirements with the various chemicals necessary to insure sharp clean images.

Assignee hereof, Elementis Specialties, Inc., has devoted substantial time and effort in the scientific pursuit of improved inks and has been issued a number of recent patents describing ink additives and formulation including U.S. Pat. Nos. 6,409,811, 5,939,475, 5,749,949, 5,723,653 and 5,591,796. Certain polyisoprene derivatives made from natural rubber sold by the assignee under the trademark Isolene have been used by assignee's customers in the past as rheological additives to impart increased viscosity to greases.

As stated above, organoclay based rheological additives are widely commercially utilized in printing inks. Such organoclay powders generally require high-speed dispersion equipment like 3-roll mills, media mills, or Cowles-blade type mixers. As discussed, there is a need in ink manufacturing process for a liquid rheological additive that does not require such milling operations. A liquid rheological additive would also be very useful as a post additive to correct the rheology of the finished (milled) inks.

Due to its outstanding physical and chemical properties, rubber has maintained its position as the preferred material in many engineering applications but surprisingly has not been seriously considered as a rheological additive for ink formulations.

### SUMMARY OF THE INVENTION

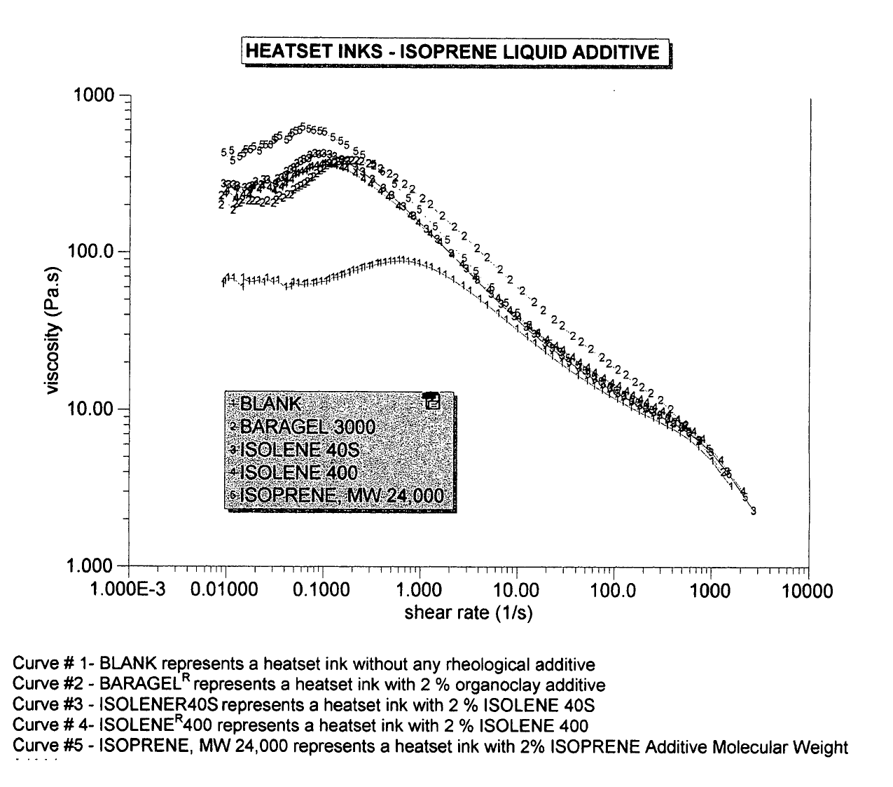

It has been found that inks particularly heatset offset inks, formulated with defined rubber derivatives as described hereafter, specifically polyisoprene liquids, as an additive, exhibit thixotropy and other unexpected desirable thickening and other properties. Such polyisoprenes can be liquids when added to a heatset offset printing ink, and will provide equal yield and the viscosity value compared to an organoclay powder, a common widely utilized ink additive. See FIG. 1, a graph, for such a performance comparison.

Ink formulations, the subject of this invention, are broadly defined as organic or non-aqueous compositions used in printing. These formulations may contain many chemicals including pigments, colorants, anti-settling additives, solvents and so on, along with the rubber additives described herein.

For the rubber polyisoprene additives, a range of specific molecular weight polyisoprenes are preferably used in this invention. For the purposes of the invention the unit for the molecular weight is daltons. Best performing polyisoprenes in terms of both rheology and ink antimisting were found to be those with a weight average molecular weight of about 10,000-40,000 daltons; most preferred were weight average molecular weight of 20,000-40,000. Weight average molecular weight, M_{w} a term well known to polymer chemists and to those skilled in the ink art, can be defined as M_{w}=●wₓMₓ where wₓ is the weight fraction of molecules whose weight is M_{w}. Such weight average molecular weight can be readily determined by chemists using a wide variety of well-known measurement equipment.

The rubber derivative should be incorporated in the ink formulation in an amount varying between about 1 to 10% by weight of the formulation either alone or preferably diluted with an organic solvent such as one or more high boiling petroleums (often called ink oil). Preferred is about 1-4% loading by weight.

### BRIEF DESCRIPTION OF THE DRAWING

The drawing—FIG. 1, shows a comparison of heatset inks of this invention compared to heatset inks using organoclays, a common ink additive, and no heatset additive at all. (Rheological profiles were measured with TA Instruments CSL²100 Controlled Stress Rheometer with a 2 cm, 2° cone and plate system). The ink containing a representative polyisoprene, weight average molecular weight 24,000, shows higher viscosity at low shear ranges compared to BARAGEL 3000, a commonly used organoclay additive and higher molecular weight polyisoprenes. This property is very important since higher viscosity at very low shear ranges is an indication of improved print sharpness.

### DETAILED DESCRIPTION OF PREFERRED EMBODIMENTS

The invention hereof is of organic ink formulations containing from about 1-10% of an additive derived from modified polyisoprenes or polyisoprenes built-up from monomers.

The additives useful for this invention can be what we call “degraded” rubbers made from polyisoprenes by known break-down techniques such as used to make the described polyisolene products or by “built-up” rubber derivatives—the most important factor is the weight average molecular weight.

Useful liquid rubbers can be prepared in a depolymerization or thermal degredation or pyrolysis process by heating polyisoprene to high temperatures for a sufficient time to cause chain scission. At temperatures above about 220° C., the rubber depolymerizes and the viscosity drops. Factors responsible for depolymerization include temperature and shear. Polyisoprene is the chemical term for natural rubber (although it can also be made in a synthetic form) and is often given the chemical name 1,3-butadiene-2-methylhomopolymer.

In the case of natural polyisoprene, the time and temperature required to reduce the viscosity can be estimated from the paper entitled “Production of Liquid Natural Rubber by Thermal Depolymerization” authored by N. M. Claramma, et al and published in the Indian J. Nat. Rubb. Res. 4(1): 1-7, 1991. As expected, the higher the temperature, the shorter the time required. Synthetic polyisoprene has similar depolymerization behavior.

To carry out the depolymerization to make the degraded rubber additives useful in the inks of this invention, any equipment capable of heating the rubber above 220° C. may be used. Heating may occur by thermal and/or generated by mechanical means. Equipment that may be used includes heated and agitated tanks, roll mills, internal mixers (Banbury or Brabender), and extruders. After the depolymerization is complete, the resulting product should be cooled to stop further depolymerization. Extrision is a preferred process to make such additive.

Additives useful in this invention include the Isolene line of products made by Elementis Specialties, Inc. of Belleville, N.J.; more preferred are variations of such line of lower weight average molecular weight products.

The rubber additive can also be made by what we call “build up” polymerization processes. For example, Kuraray materials manufactured by Kuraray Co. Ltd., a Japanese company, are made as 1,4-polyisoprene having specified narrow molecular weight distributions often from a gaseous starting material. The build-up additive of the inks of this invention can also be made by anionic polymerization techniques, as well as the Ziegler-Natta process which is essentially catalyzed polymerization. Free radical polymerization techniques can also produce satisfactory additives for the inventive ink formulation.

Modified built up polyisoprene rubbers are also useful—see for example Japanese Patent Application No. 55-091884 describing a modified liquid polyisoprene rubber having added N-hydroxyhydrocarbyl—maleimide as an example of such modified rubbers. We include such modified rubbers with our definition of useful polyisoprenes.

Simply stated, the additives useful in formulating the inks of this invention are generally flowable, pourable, largely 100% active polyisoprene derivative compositions of a defined weight average molecular weight. These may be prepared either by the aforedescribed break-down or build-up processes.

The additives of this invention are thus relatively low molecular weight, liquid polymers derived from rubber. The chemical backbone is preferably 1,4-polyisoprene. Liquid polyisoprene (rubber), the starting ingredient for the break down process is a translucent, honey-colored liquid in bulk volume and virtually clear in thin films. It offers when synthetic the benefits of liquid natural rubber and other properties without the dark color of natural rubber.

Preferred additives can be made from both synthetic and from natural rubber. These provide good rheological performance properties in the finished ink system. The attributes it is believed result from the inherent properties of polyisoprene rubber.

The physical characteristics of representative polyisoprene derived liquid polymers useful for this invention include those in the following tables.

As previously described, a range of molecular weight polyisoprenes were found useful. Best performing polyisoprenes in terms of the balance between rheology and ink misting had a weight average molecular weight of 10,000-40,000.

More importantly, these are viscous liquids at normal ink processing temperatures. The table indicates the viscosity (in centipoises) when heated to typical process temperatures of the above products.

The following tests were run to measure viscosity, misting and other properties of that the ink formulation, with various additives, encountered. The results show the improvements possible with this invention.

The additives of the present invention were incorporated into a heatset ink formulation at a loading of 2% (w/w) and a number of tests were conducted to determine the effectiveness of the material.

The components of a heatset blue ink system are described in Formulation A, and the procedure for the preparation of ink samples is described under Ink Preparation.

FORMULATION A - HEATSET BLUE FORMULA

| Component | Generic Name | Supplier | Weight % |
|---|---|---|---|
| BL6036AG Phthalo Blue | Flush | Magruder | 34 |
| Local A7T | Heatset Flush and | Lawyer | 52 |
| | Grinding Vehicle | | |
| Magiesol 470 | Ink Oil | Magie Brothers | 14 |
| Rheological Additive | | | 2 |

Ink Preparation

A base ink from the components described in formulation is prepared as follows: The ingredients without the rheological additive were mixed using a Dispermat model CV model at 3000 RPM fitted with a heavy duty 1 inch impeller for 15 minutes. The mixture was then passed through a three-roll mill to achieve speckle free ink. It was then allowed to cool to room temperature and allowed to equilibrate for at least 24-hours.

The rheological additives were incorporated to the base ink and mixed for 15 minutes at 3000 RPM at room temperature using Cowles blade. The temperature of the ink reached 115° F. due to high-speed shear. The blending ratio of the base ink to the rheological additive is 98:2.

After the inks were made, they were allowed to equilibrate to room temperature overnight, and the ink properties were measured as described below:

Fineness of grind was measured on a NPRI Grindometer G-1 (25 micron) in accordance with ASTM D1316-93.

Viscosity measurements were made on a Duke Rheometer D2052.

The test prints were made on an automated proofing press and the prints were dried on a Sinvatrol dryer in accordance with ASTM D6073-95.

Gloss was measured using 60° angle Gardner glossmeter at different points over the ink print, and these values were averaged.

Tack was measured with a Thwing-Albeert Electronic Inkometer, Model 101, in accordance with ASTM D4361-89 at 1200 RPM at 90° F. for one minute.

Emulsification (water pickup) was measured with a Duke Emulsification tester Model D-10 in accordance with ASTM D4942-89 using a 5 minute Single Point Water Pickup Method.

Misting was determined by visual observation of the ink collected on a clean 5½″×7″ sheet of paper placed under the inkometer rollers during a tack measurement. Misting was then categorized poor to excellent on a scale of 1 to 10, 1 being poor and 10 as excellent. The base ink was considered as 5.

The ink formulation used was a common heatset offset ink formulation containing pigments as shown in Table I with an organoclay, a widely used ink additive for such formulations, as the control. Table 1 describes the properties of preferred additives which are degraded polyisoprene derivatives with a weight average molecular weight of 10,000 to 40,000 and a built-up polyisoprene derivative (Kuraray LIR 30).

TABLE 1

| | | Viscosity | | |
|---|---|---|---|---|
| | | (cP) at | | |
| Sample No. | Additive Type | 100° F. | Mₙ | M_{w} |
| 1 | Additive A | 11000 | 11343 | 18684 |
| 2 | Additive B | 15200 | 13432 | 24826 |
| 3 | Additive C | 14500 | 14338 | 24764 |
| 4 | Additive D | 25900 | 15579 | 27023 |
| 5 | Additive E | 28600 | 15990 | 29324 |
| 6 | ISOLENE ® 40S | 40000 | 14170 | 40000 |
| 7 | ISOLENE ® 400S | 400000 | 18563 | 400000 |
| 8 | BARAGEL 3000 | Powder | N/A | N/A |
| | Organoclay | | | |
| 9 | Kuraray LIR 30 | 7500 | N/A | N/A |
| 10 | Kuraray LIR 50 | 48000 | N/A | 47000 |

ISOLENE AND BARAGEL are trademarks of Elementis Specialties, Inc. Kuraray materials are from Kuraray Company, Ltd, Japan.
Molecular weights were measured (vs. polystyrene) using gel permeation chromatography (GPC) on a Waters GPC consisting of a model 510 pump, model 410 differential Refrectometer, model 717 plus autosampler and a column heater. Data collection and analysis were done using Version 4.0 of the Millennium software. Two GPC columns were used (Waters HR-2 and HR-4) at a temperature of 40 C. The mobile phase was HPLC grade toluene flowing at 0.3 mL/min.
Viscosities were measured with a Wells-Brookfield 5XHBT Viscometer with the cup temperature controlled at 100 F.

The present invention will be better understood by reference to the following examples.

### Example 1

100 parts of heatset offset ink base (Formulation A and Table 1) represents the ink without any additive. Viscosity of the product was tested on a high shear viscometer and the misting was evaluated on an electronic inkometer.

### Example 2

98 parts of the heatset offset base ink was mixed with 2 parts of the additive sample # 1. The viscosity and misting data were then collected.

### Example 3

98 parts of the heatset offset base ink was mixed wit 2 parts of the additive sample # 2. The viscosity and misting data were then collected.

### Example 4

98 parts of the heatset offset base ink was mixed wit 2 parts of the additive sample # 3. The viscosity and misting data were then collected.

### Example 5

98 parts of the heatset offset base ink was mixed wit 2 parts of the additive sample # 4. The viscosity and misting data were then collected.

### Example 6

98 parts of the heatset offset base ink was mixed wit 2 parts of the additive sample # 5. The viscosity and misting data were then collected.

### Example 7

98 parts of the heatset offset base ink was mixed wit 2 parts of the additive sample #6. The viscosity and misting data were then collected.

### Example 8

98 parts of the heatset offset base ink was mixed wit 2 parts of the additive sample # 7. The viscosity and misting data were then collected.

### Example 9

98 parts of the heatset offset base ink was mixed wit 2 parts of the additive sample # 8. The viscosity and misting data were then collected.

### Example 10

98 parts of the heatset offset base ink was mixed wit 2 parts of the additive sample # 9. The viscosity and misting data were then collected.

### Example 11

98 parts of the heatset offset base ink was mixed wit 2 parts of the additive sample # 10. The viscosity and misting data were then collected.

Table 2 set forth below describes the comparison in performance properties of Examples 1-11.

TABLE 2

| | | | Antimist | Viscosity (poise) of | | |
|---|---|---|---|---|---|---|
| | | Additive | (1 = poor) | the ink at shear rate | | |
| Example No | Rheological Additive | Amount (%) | (10 = best | 0.1 (1/sec) | 1.0 (1/sec) | 10.0 (1/sec) |
| 1 | None | 0 | 5 | 650 | 695 | 275 |
| 2 | Additive A | 2 | 5 | 4591 | 1800 | 392 |
| 3 | Additive B | 2 | 5 | 4636 | 1700 | 400 |
| 4 | Additive C | 2 | 5 | 5750 | 1800 | 390 |
| 5 | Additive D | 2 | 5 | 6320 | 1950 | 400 |
| 6 | Additive E | 2 | 6 | 6970 | 2300 | 490 |
| 7 | Isolene 40S | 2 | 1 | 4200 | 1550 | 370 |
| 8 | Isolene 400S | 2 | 1 | 3630 | 1450 | 390 |
| 9 | Baragel 3000 | 2 | 10 | 3356 | 2286 | 592 |
| 10 | Kurarey LIR 30 | 2 | 5 | 6500 | 2250 | 500 |
| 11 | Kurarey LIR 50 | 2 | 1 | 2700 | 1500 | 490 |

ISOLENE AND BARAGEL are trademarks of Elementis Specialties, Inc.
   Discussion of above Results:

The ink formulations containing rubber additives provided superior and excellent results compared to common standard additives. As may be seen from Table 2, the ink compositions of the present invention exemplified by Examples 2-6 exhibited superior thickening efficiency while maintaining mist control properties of the control sample of Example #1. These inventive inks are formulated with polyisoprene additives of weight average molecular weight in the range of 10,000-40,000.

While the rheology of the ink is very important, the antimist characteristic of the ink is also critically important for quality printing and therefore a rheological additive used should not adversely affect antimisting properties of the inks.

Ink misting is the term to describe airborne droplets of the ink ejected from high speed printing rollers. Ink misting contaminates the pressroom and causes print quality problems as well as health and hazard concerns for the pressroom personnel.

Examples 7 is a commercially available products from Elementis Specialties, Inc (Isolene 40S) which is within the invention although the anti-misting characteristics of these products are not optimum. Kuraray LIR 30, a low molecular weight “built-up polymer” also showed excellent efficiency with acceptable properties, in contrast to the high molecular weight Kuraray material.

The foregoing background, description and examples have been set forth merely to illustrate the invention and are not intended to be limiting. Since many modifications and simple changes of the disclosed embodiments incorporating the spirit and substance of the invention may occur to persons skilled in the art, the invention should be construed to include everything within the scope of the appended claims, equivalents thereof and obvious variations thereof.

1. A non-aqueous ink formulation comprising a polyisoprene derivative.

2. The ink formulation of claim 1 wherein the derivative has a weight average molecular weight between 10,000 and 40,000.

3. The ink formulation of claim 2 wherein the derivative has a weight average molecular weight between 10,000 and 30,000.

4. The ink formulation of claim 1 also containing one or more pigments and a high boiling petroleum.

5. The ink formulation of claim 1 wherein the ink formulation is selected from the group consisting of heatset offset ink formulations, sheet-fed ink formulations and UV curable ink formulations.

6. The ink formulation of claim 1 wherein the derivative is selected from the group consisting of degraded and built-up derivatives.

7. An additive for an ink formulation comprising a polyisoprene derivative and a solvent.

8. The additive of claim 7 wherein the solvent is high boiling petroleum.

9. The additive of claim 7 wherein the polyisoprene derivative has a weight average molecular weight between 10,000 and 40,000.

10. The additive of claim 7 wherein the additive was selected from the group consisting of degraded and built-up derivatives.

11. A non-aqueous ink formulation comprising a polyisoprene derivative wherein the derivative makes up between 1 to 10% by weight of the ink formulation.

12. The formulation of claim 11 wherein the derivative has a weight average molecular weight between 10,000 and 40,000.

13. A method of providing rheological properties to a non-aqueous ink formulation comprising:
a. preparing a non-aqueous ink formulation and
b. dispersing into such formulation a polyisoprene derivative.

14. The method of claim 13 wherein the polyisoprene derivative has a weight average molecular weight between 10,000 and 40,000.
